(19) United States
(12) Patent Application Publication
(10) Pub. No.: US 2024/0120621 A1
(43) Pub. Date: Apr. 11, 2024

(54) PREPARING METHOD OF ALL-SOLID-STATE RECHARGEABLE BATTERY MODULE THROUGH TEMPERATURE CONTROL AND ALL-SOLID-STATE RECHARGEABLE BATTERY

(71) Applicant: SAMSUNG SDI CO., LTD., Yongin-si (KR)

(72) Inventors: Isaac SHIN, Yongin-si (KR); Riyul KIM, Yongin-si (KR); Jaegu YOON, Yongin-si (KR)

(21) Appl. No.: 18/376,933

(22) Filed: Oct. 5, 2023

(30) Foreign Application Priority Data
Oct. 7, 2022 (KR) 10-2022-0128380

(51) Int. Cl. H01M 50/486; H01M 10/04; H01M 50/103; H01M 50/474

(52) U.S. Cl. CPC H01M 50/486; H01M 10/049; H01M 50/103; H01M 50/474

(57) ABSTRACT

An all-solid-state rechargeable battery, and a preparing method of an all-solid-state rechargeable battery module, the all-solid-state rechargeable battery having a stack including two or more unit cells, each unit cell including a positive electrode, a negative electrode, and a solid electrolyte layer between the positive electrode and the negative electrode, and an elastic sheet between the unit cells, and a battery case housing the stack, wherein the elastic sheet contains or includes a polymer, and the polymer has a glass transition temperature (T_{g}) of about −150° C. to about 0° C.

### CROSS-REFERENCE TO RELATED APPLICATION

This application claims priority to and the benefit of Korean Patent Application No. 10-2022-0128380 filed in the Korean Intellectual Property Office on Oct. 7, 2022, the entire contents of which are incorporated herein by reference.

### BACKGROUND

### 1. Field

A preparing method of an all-solid-state rechargeable battery module through temperature control, and an all-solid-state rechargeable battery are disclosed.

### 2. Description of the Related Art

Recently, as the risk of explosion of a battery using a liquid electrolyte has been reported, development of an all-solid-state rechargeable battery has been actively conducted. An all-solid-state rechargeable battery refers to a battery in which all materials are solid, and in particular, a battery using a solid electrolyte. This all-solid-state rechargeable battery is safe with no risk of explosion due to leakage of the electrolyte and also easily prepared into a thin battery.

### SUMMARY

Embodiments are directed to a preparing method of an all-solid-state rechargeable battery module, the method including preparing a stack having two or more unit cells, each unit cell having a positive electrode, a negative electrode, and a solid electrolyte layer between the positive electrode and the negative electrode, providing an elastic sheet containing a polymer between the unit cells, pressurizing the stack, cooling the pressurized stack to obtain a stack in a pressurized state, inserting the cooled stack in a pressurized state into a battery case, and heating the battery case and the inserted stack.

In an implementation, the elastic sheet is provided with a polymer having a glass transition temperature (T_{g}) of about −150° C. to about 0° C.

In an implementation of embodiments, cooling the pressurized stack is conducted to lower a temperature of the pressurized stack to less than about 5° C., and heating the battery case and the inserted stack is conducted to raise a temperature of the battery case and inserted stack to greater than or equal to about 5° C.

In an implementation, cooling the pressurized stack is conducted to lower a temperature of the pressurized stack to a range of ±50° C. of a glass transition temperature of the polymer in the elastic sheet and less than about 5° C.

In an implementation, heating the battery case and the inserted stack is conducted to raise a temperature of the battery case and inserted stack to room temperature (20±5° C.).

In an implementation, pressurizing the stack is conducted at a pressure of about 1 MPa to about 10 MPa.

In an implementation, in pressurizing the stack, the elastic sheet shrinks in a thickness direction, and a compressive strain of the elastic sheet by the pressurizing is about 30% to about 70%.

In an implementation, a thickness of the elastic sheet before the pressurizing is about 50 μm to about 500 μm, and a thickness of the elastic sheet after the pressurizing is about 15 μm to about 350 μm.

In an implementation, during heating of the battery case and the inserted stack, the elastic sheet expands about 40 μm to about 400 μm in a thickness direction.

In an implementation, the polymer of the elastic sheet includes polyurethane, polyacrylate, silicon, fluorine-based polymer, a copolymer thereof, or a combination thereof.

In an implementation, the elastic sheet is provided at an outermost side of the stack inside the battery case, before pressurizing the stack.

In an implementation, the battery case may be a can type or a prismatic can.

Alternative embodiments are directed to an all-solid-state rechargeable battery, including a stack having two or more unit cells, each unit cell including a positive electrode, a negative electrode, and a solid electrolyte layer between the positive electrode and the negative electrode, an elastic sheet between the unit cells, and a battery case housing the stack, wherein the elastic sheet includes a polymer having a glass transition temperature (T_{g}) of about −150° C. to about 0° C.

In an implementation, the polymer of the elastic sheet in all-solid-state rechargeable battery includes polyurethane, polyacrylate, silicon, fluorine-based polymer, a copolymer thereof, or a combination thereof.

In an implementation, the elastic sheet in the battery case has a thickness of about 40 μm to about 400 μm.

In an implementation, the elastic sheet has a compressive strain of about 30% to about 70% under a pressure of 6 MPa at 25° C.

In an implementation, the battery case of the all-solid-state rechargeable battery may be a can type or a prismatic can.

In an implementation, the all-solid-state rechargeable battery the elastic sheet is at an outermost side of the stack inside the battery case, e.g., surround or envelope the stack.

Provided are a preparing method of an all-solid-state rechargeable battery module that can be designed and prepared efficiently and economically regardless of the shape of a battery case, and an all-solid-state rechargeable battery. According to some example embodiments, it is possible to apply a hard battery case, such as a can type, regardless of the shape of the battery case, and it is possible to design and prepare an efficient and economical battery.

### BRIEF DESCRIPTION OF THE DRAWINGS

FIG. 1 is a schematic diagram showing a preparing method of an all-solid-state rechargeable battery module according to example embodiments.

FIG. 2 is a schematic, cross-sectional view of an all-solid-state rechargeable battery according to example embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that if a layer or element is referred to as being “on” another layer or substrate, it can be directly on the other layer or substrate, or intervening layers may also be present. Further, it will be understood that if a layer is referred to as being “under” another layer, it can be directly under, and one or more intervening layers may also be present. In addition, it will also be understood that if a layer is referred to as being “between” two layers, it can be the only layer between the two layers, or one or more intervening layers may also be present. Like reference numerals refer to like elements throughout.

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present invention. The singular expression includes the plural expression unless the context clearly dictates otherwise.

As used herein, “combination thereof” means a mixture, laminate, composite, copolymer, alloy, blend, reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that if an element such as a layer, film, region, or substrate is referred to as being “on” another element, it can be directly on the other element or intervening elements may also be present. In contrast, if an element is referred to as being “directly on” another element, there are no intervening elements present.

In addition, “layer” herein includes not only a shape formed on the whole surface if viewed from a plan view, but also a shape formed on a partial surface.

In addition, the average particle diameter may be measured by a method well known to those skilled in the art, for example, may be measured by a particle size analyzer, or may be measured by a transmission electron micrograph or a scanning electron micrograph. Alternatively, it is possible to obtain an average particle diameter value by measuring using a dynamic light scattering method, performing data analysis, counting the number of particles for each particle size range, and calculating from this. The average particle diameter may be measured by a microscopic image or a particle size analyzer, and may mean a diameter (D50) of particles having a cumulative volume of 50 volume % in a particle size distribution.

Herein, “or” is not to be construed as an exclusive meaning, for example, “A or B” is construed to include A, B, A+B, and the like.

Preparing Method of all-Solid-State Rechargeable Battery Module

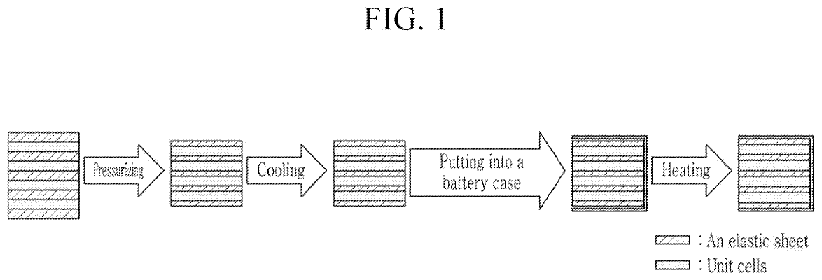

In some example embodiments, a preparing method of an all-solid-state rechargeable battery module includes preparing a stack including two or more unit cells, each unit cell including a positive electrode, a negative electrode, and a solid electrolyte layer between the positive electrode and the negative electrode, and including an elastic sheet containing a polymer between and around the unit cells; pressurizing the stack; cooling the pressurized stack to prepare a stack maintained in a pressurized state; putting the cooled stack into a battery case; and heating the battery case in which the stack is housed. A schematic process is shown in FIG. 1 for easy understanding of the preparing method of the all-solid-state rechargeable battery module according to some example embodiments.

The unit cell is a unit cell of an all-solid-state rechargeable battery, in which a positive electrode, a solid electrolyte layer, and a negative electrode are sequentially stacked. The elastic sheet is interposed between the unit cells or placed at an outermost side of the stack, e.g., to surround or envelope the stack. The elastic sheet may be composed of a polymer, and the polymer may have a specific glass transition temperature (T_{g}). Such a polymer exhibits brittle properties at T_{g} or less or around T_{g}, since polymer chains become unable to move and hard like glass, but at T_{g} or higher, exhibits rubber-like properties, since the polymer chains become able to move, and thus have elasticity. In some example embodiments, T_{g} of the polymer may be used to design an all-solid-state rechargeable battery, which has been up to now impossible to put into a hard battery case, to be manufactured regardless of a battery case shape.

The polymer constituting the elastic sheet may have relatively low T_{g}, that is, is a low temperature T_{g} polymer. For example, the polymer constituting the elastic sheet may have a glass transition temperature of about −150° C. to about 0° C., for example, about −140° C. to about −10° C., or about −130° C. to about −20° C. If an elastic sheet contains a polymer having T_{g} within these ranges, cooling and heating temperatures are easy to design in the process of manufacturing a module according to some example embodiments, and thus it is possible to manufacture an all-solid-state rechargeable battery in an efficient and economical way, regardless of the size and shape of the battery case.

The polymer of the elastic sheet may include, for example, polyurethane, polyacrylate, silicone, a fluorine-based polymer, a copolymer thereof, or a combination thereof, but is not limited thereto. The polyurethane refers to a homopolymer or copolymer having a urethane group, the polyacrylate refers to a homopolymer or copolymer having an acryl group, the silicon, which may be a silicon resin, refers to a homopolymer or copolymer containing silicon, and the fluorine-based polymer refers to a homopolymer or copolymer containing fluorine. These polymers may exhibit appropriate elasticity, modulus, and compressive strain and thus be suitable for the elastic sheets.

In the preparing method of an all-solid-state rechargeable battery module, the stack may be pressurized to a smaller size than the battery case, for example, to a pressure of about 1 MPa to about 10 MPa, for example, about 2 MPa to about 9 MPa, about 3 MPa to about 8 MPa, about 4 MPa to about 7 MPa, or about 5 MPa to about 6 MPa. Through this pressurizing process, the elastic sheet may contract in a thickness direction, through which the overall thickness and volume of the stack may be reduced. If the pressurizing is performed within the pressure ranges, the stack may be manufactured to have an appropriate thickness without adversely affecting the unit cells.

In some example embodiments, the stack is cooled after pressurizing the stack, so that the stack may maintain the pressurized state. Herein, the cooling may be performed to a temperature near T_{g} of a polymer constituting the elastic sheet. If the cooling is designed to lower the temperature near T_{g}, the elastic sheet may not recover an elastic force but maintain a hard state, that is, a contracted state. Subsequently, the cooled stack is inserted into a battery case. The cooled stack maintains the smaller size than the case, even if not under the pressurized state, and thus may be easily inserted into the battery case. Lastly, the battery case in which the sack is housed may be heated, so that the elastic sheet may also be heated and recover elastic force and expand again, and accordingly, as the stack increases in thickness and volume, and thereby, as pressure inside the battery case increases, the electrode materials in the stack may maintain the point contacts.

The cooling of the pressurized stack may be, for example, lowering the temperature of the pressurized stack to less than about 5° C. or less than or equal to about 0° C. This is a concept of lowering the temperature to a temperature near T_{g} of an elastic sheet polymer, which means that the cooling is not necessary to perform to the same as T_{g} or less of the polymer, for example, to a temperature range of T_{g}±50° C. of the polymer. The stack should maintain the pressurized state, until inserted into the battery case after the pressurizing, for example, for about 5 minutes or less or about 2 minutes or less. Even though the cooling is performed to a higher temperature than T_{g} of the polymer, since the stack may maintain the pressurized state for predetermined time, the cooling may be performed to an appropriate temperature near T_{g} according to types of the applied polymer. For example, if a polyurethane elastic sheet having T_{g} of about −50° C. is applied, the stack, if cooled to about 0° C., may maintain the pressurized state for about 83 seconds, which is sufficient time within which to insert the cooled stack inside the battery case.

Herein, the “pressurized state” means a state that after a shape of an object is changed by pressurization, the transformed shape is maintained, even after the external pressure disappears.

The heating of the battery case in which the stack is housed may be, for example, raising a temperature to greater than or equal to about 5° C., for example room temperature, that is to about 20±5° C., or to a temperature higher than room temperature. Within these temperature ranges, since polymer chains of the elastic sheet may freely move, an elastic force of the elastic sheet may be rapidly recovered. For example, if a polyurethane elastic sheet with T_{g} of about −50° C. is applied, if a temperature of the battery case in which the stack is housed is increased to about 5° C. or more, the elastic force of the elastic sheet may be recovered within about 4 seconds, and if the temperature is increased to about 10° C. or about 15° C., the elastic force of the elastic sheet may be recovered within about 0.3 seconds. Herein, the recovery of the elastic force may mean that the elastic sheet may recover about 70% or more of the thickness before the pressurizing. The cooling temperature and the heating temperature may be appropriately designed according to T_{g} of a polymer constituting the elastic sheet.

The elastic sheet may be said to contract in a thickness direction during the pressurizing but expand in the thickness direction during the heating following the pressurizing. The elastic sheet may have compressive strain of about 30% to about 70% or for example, about 33% to about 67%. If the compressive strain ranges are satisfied, the elastic sheet may sufficiently serve to relieve stress in the all-solid-state rechargeable battery and decrease the internal pressure change and absorb the impacts.

Herein, the compressive strain may be referred to as a ratio of a thickness change reduced by pressurizing to a thickness of the elastic sheet before pressurizing, and may be referred to as a value calculated by Equation 1. Herein, the compressive strain may be measured at 25° C., a pressure during pressurizing may be, for example, about 6 MPa, and a thickness before pressurizing may be, for example, about 300 μm.

[(Thickness before pressurizing)−(Thickness after pressurizing)]/(Thickness before pressurizing)×100 [Equation 1]

The thickness of the elastic sheet before the pressurizing may be, for example, about 50 μm to about 500 μm, for example, about 100 μm to about 450 am, about 150 m to about 400 μm, or about 200 μm to about 350 am. The thickness before pressurizing may mean a thickness at 25° C. normal pressure.

The thickness of the elastic sheet after the pressurizing may be, for example, about 15 μm to about 350 μm, for example, about 20 μm to about 300 μm, about 30 μm to about 250 μm, about 40 μm to about 200 μm, or about 50 μm to about 150 μm.

In addition, the thickness of the elastic sheet expanded in the battery case may be, for example, about 40 μm to about 400 μm, for example, about 50 μm to about 350 m, about 100 μm to about 300 μm, or about 150 μm to about 250 μm. The thickness of the elastic sheet expanded in the battery case may be about 70% to about 95%, or about 70% to about 85% of the thickness before pressurizing. In this case, the elastic sheet in the battery case can be said to be to be desirable for withstanding internal pressure while relieving stress.

If the thicknesses of the elastic sheet before, after, and after expansion satisfy the above ranges, respectively, the elastic sheet is advantageous in relieving stress, reducing internal pressure change, and mitigating impact in the battery.

The battery case may be of any shape and may be a flexible case such as a pouch type or a hard case such as a can type, including prismatic can. In some example embodiments, the battery case may be a can of each type, with virtually no limit to the number of shapes and sizes.

All-Solid-State Rechargeable Battery

Some example embodiments provide an all-solid-state rechargeable battery that can be prepared according to the aforementioned method. Specifically, the all-solid-state rechargeable battery according to some example embodiments includes a stack including two or more unit cells including a positive electrode, a negative electrode, and a solid electrolyte layer between the positive electrode and the negative electrode and an elastic sheet between the unit cells, and a battery case housing the stack. Herein, the elastic sheet includes a polymer, and the polymer has a glass transition temperature (T_{g}) of about −150° C. to about 0° C. The all-solid-state rechargeable battery can be efficiently and economically prepared regardless of the type of battery case by applying a polymer having a specific T_{g} range to the elastic sheet.

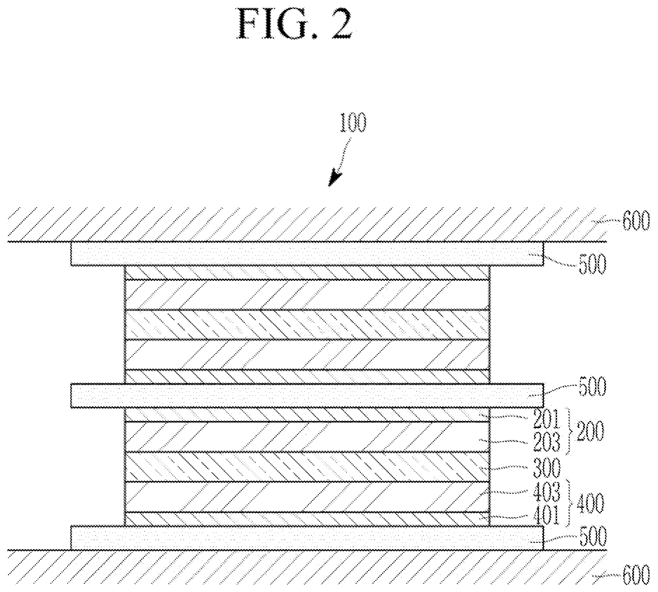

FIG. 2 is a cross-sectional view of an all-solid-state rechargeable battery according to some example embodiments. Referring to FIG. 2, the all-solid-state battery 100 may have a structure like that of an electrode assembly, in which a negative electrode 400 including a negative current collector 401 and a negative electrode active material layer 403, a solid electrolyte layer 300, and a positive electrode 200 including a positive electrode active material layer 203 and a positive current collector 201 are stacked, is housed in a battery case 600. The all-solid-state battery 100 may further include at least one elastic layer 500 on the outside of at least either one of the positive electrode 200 and the negative electrode 400. The elastic sheet 500 may be between the unit cells and may be provided at an outermost portion of the cell stack, i.e., surround or envelope the stack of unit cells.

FIG. 2 shows an assembly in which two unit cells including a negative electrode 400, a solid electrolyte layer 300, and a positive electrode 200 are stacked, but the assembly may include three or more, for example, 2 to 100, 3 to 50, or 4 to 20 unit cells.

Here, details of the elastic sheet are omitted because they are the same as described above.

Positive Electrode

A positive electrode for an all-solid-state rechargeable battery according to some example embodiments includes, for example, a current collector and a positive electrode active material layer on the current collector. The positive electrode active material layer includes a positive electrode active material and a solid electrolyte and optionally a binder and/or a conductive material.

Positive Electrode Active Material

The positive electrode active material may be applied without limitation as long as it is generally used in an all-solid-state rechargeable battery. For example, the positive electrode active material may be a compound capable of intercalating and deintercalating lithium, and may include a compound represented by one of the following chemical formulas.

LiₐA_{1-b}X_{b}D₂ (0.90≤a≤1.8,0≤b≤0.5);

LiₐA_{1-b}X_{b}O_{2-c}D_{c} (0.90≤a≤1.8,0≤b≤0.5,0≤c≤0.05);

LiₐE_{1-b}X_{b}O_{2-c}D_{c} (0.90≤a≤1.8,0≤b≤0.5,0≤c≤0.05);

LiₐE_{2-b}X_{b}O_{4-c}D_{c} (0.90≤a≤1.8,0≤b≤0.5,0≤c≤0.05);

LiₐNi_{1-b-c}Co_{b}X_{c}D_{α} (0.90≤a≤1.8,0≤b≤0.5,0≤c≤0.5,0≤α≤2);

LiₐNi_{1-b-c}Co_{b}X_{c}O_{2-α}T_{α} (0.90≤a≤1.8,0≤b≤0.5,0≤c≤0.05,0≤α≤2);

LiₐNi_{1-b-c}Co_{b}X_{c}O_{2-α}T₂ (0.90≤a≤1.8,0≤b≤0.5,0≤c≤0.05,0≤α≤2);

LiₐNi_{1-b-c}Mn_{b}X_{c}D_{α} (0.90≤a≤1.8,0≤b≤0.5,0≤c≤0.05,0≤α≤2);

LiₐNi_{1-b-c}Mn_{b}X_{c}O_{2-α}T_{α} (0.90≤a≤1.8,0≤b≤0.5,0≤c≤0.05,0≤α≤2);

LiₐNi_{1-b-c}Mn_{b}X_{c}O_{2-α}T₂ (0.90≤a≤1.8,0≤b≤0.5,0≤c≤0.05,0≤α≤2);

LiₐNi_{b}E_{c}G_{d}O₂(0.90≤a≤1.8,0≤b≤0.9,0≤c≤0.5,0.001≤d≤0.1);

LiₐNi_{b}Co_{c}Mn_{d}GₑO₂ (0.90≤a≤1.8,0≤b≤0.9,0≤c≤0.5,0≤d≤0.5,0.001≤e≤0.1);

LiₐNiG_{b}O₂ (0.90≤a≤1.8,0.001≤b≤0.1);

LiₐCoG_{b}O₂ (0.90≤a≤1.8,0.001≤b≤0.1);

LiₐMn_{1-b}G_{b}O₂ (0.90≤a≤1.8,0.001≤b≤0.1);

LiₐMn₂G_{b}O₄ (0.90≤a≤1.8,0.001≤b≤0.1);

LiₐMn_{1-g}G_{g}PO₄ (0.90≤a≤1.8,0≤g≤0.5);

QO₂; QS₂; LiQS₂;

V₂O₅; LiV₂O₅;

LiZO₂;

LiNiVO₄;

Li_{(3-f)}Fe₂(PO₄)₃ (0≤f≤2);

Li_{(3-f)}Fe₂(PO₄)₃ (0≤f≤2);

LiₐFePO₄ (0.90≤a≤1.8).

In the chemical formulas, A is selected from Ni, Co, Mn, and a combination thereof, X is selected from Al, Ni, Co, Mn, Cr, Fe, Mg, Sr, V, rare earth elements, and a combination thereof, D is selected from O, F, S, P, and a combination thereof, E is selected from Co, Mn, and a combination thereof; T is selected from F, S, P, and a combination thereof; G is selected from Al, Cr, Mn, Fe, Mg, La, Ce, Sr, V, and a combination thereof: Q is selected from Ti, Mo, Mn, and a combination thereof, Z is selected from Cr, V, Fe, Sc, Y, and a combination thereof, and J is selected from V, Cr, Mn, Co, Ni, Cu, and a combination thereof.

The positive electrode active material may be, for example, a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NCM), a lithium nickel manganese oxide (NM), a lithium manganese oxide (LMO), or lithium iron phosphate (LFP).

The positive electrode active material may include a lithium nickel-based oxide represented by Chemical Formula 1, a lithium cobalt-based oxide represented by Chemical Formula 2, a lithium iron phosphate-based compound represented by Chemical Formula 3, or a combination thereof.

Liₐ₁Niₓ₁M¹_{y1}M²_{1-x1-y1}O₂ [Chemical Formula 1]

In Chemical Formula 1, 0.9≤a1≤1.8, 0.3≤x1≤1, 0≤y1≤0.7, and M¹ and M² are each independently one or more element selected from Al, B, Ba, Ca, Ce, Co, Cr, Cu, F, Fe, Mg, Mn, Mo, Nb, P, S, Si, Sr, Ti, V, W, and Zr.

Liₐ₂Coₓ₂M³₁₋ₓ₂O₂ [Chemical Formula 2]

In Chemical Formula 2, 0.9≤a2≤1.8, 0.6≤x2≤1, and M³ is one or more element selected from Al, B, Ba, Ca, Ce, Cr, Cu, F, Fe, Mg, Mn, Mo, Nb, P, S, Si, Sr, Ti, V, W, and Zr.

Liₐ₃Feₓ₃M⁴₍₁₋ₓ₃₎PO₄ [Chemical Formula 3]

In Chemical Formula 3, 0.9≤a3≤1.8, 0.6≤x3≤1, and M⁴ is one or more element selected from Al, B, Ba, Ca, Ce, Co, Cr, Cu, F, Fe, Mg, Mn, Mo, Nb, P, S, Si, Sr, Ti, V, W, and Zr.

An average particle diameter (D50) of the positive electrode active material may be about 1 μm to about 25 μm, for example, about 3 μm to about 25 μm, about 5 μm to about 25 μm, about 5 μm to about 20 μm, about 8 μm to about 20 μm, or about 10 μm to about 18 μm. A positive electrode active material having such a particle size range may be harmoniously mixed with other components in a positive electrode active material layer and may realize high capacity and high energy density.

The positive electrode active material may be in the form of secondary particles formed by aggregating a plurality of primary particles, or may be in the form of single particles. In addition, the positive electrode active material may have a spherical or near-spherical shape, or may have a polyhedral or amorphous shape.

Solid Electrolyte

The solid electrolyte may include a sulfide-based solid electrolyte, an oxide-based solid electrolyte, or a combination thereof.

The sulfide-based solid electrolyte particles may include, for example Li₂S—P₂S₅, Li₂S—P₂S₅—LiX (wherein X is a halogen element, for example I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, LiS—B₂S₃, Li₂S—P₂S₅—ZₘSₙ (wherein m and n is each an integer and Z is Ge, Zn or Ga), Li₂S—GeS₂, Li₂S—SiS₂—Li₃PO₄, Li₂S—SiS₂—LiₚMO_{q} (wherein p and q each an integer and M is P, Si, Ge, B, Al, Ga, or In), or a combination thereof.

Such a sulfide-based solid electrolyte may be obtained by, for example, mixing Li₂S and P₂S₅ in a mole ratio of about 50:50 to about 90:10 or about 50:50 to about 80:20 and optionally performing heat-treatment. Within the above mixing ratio range, a sulfide-based solid electrolyte having excellent ion conductivity may be prepared. The ion conductivity may be further improved by adding SiS₂, GeS₂, B₂S₃, and the like as other components thereto.

Mechanical milling or a solution method may be applied as a mixing method of sulfur-containing raw materials for preparing a sulfide-based solid electrolyte. The mechanical milling is to make starting materials into particulates by putting the starting materials, ball mills, and the like in a reactor and fervently stirring them. The solution method may be performed by mixing the starting materials in a solvent to obtain a solid electrolyte as a precipitate. In addition, in the case of heat-treatment after mixing, crystals of the solid electrolyte may be more robust and ion conductivity may be improved. For example, the sulfide-based solid electrolyte may be prepared by mixing sulfur-containing raw materials and heat-treating the mixture two or more times. In this case, a sulfide-based solid electrolyte having high ion conductivity and robustness may be prepared.

For example, the sulfide-based solid electrolyte particles may include argyrodite-type sulfide. The argyrodite-type sulfide may be, for example, represented by the chemical formula, LiₐM_{b}P_{c}S_{d}Aₑ (wherein a, b, c, d, and e are all 0 or more and 12 or less, M is Ge, Sn, Si, or a combination thereof, and A is F, Cl, Br, or I), and as a specific example, it may be represented by the chemical formula of Li₇₋ₓPS₆₋ₓAₓ (wherein x is 0.2 or more and 1.8 or less, and A is F, Cl, Br, or I). Specifically, the argyrodite-type sulfide may be Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, and the like.

The sulfide-based solid electrolyte particles including such argyrodite-type sulfide may have high ion conductivity close to the range of about 10-4 to about 10-2 S/cm, which is the ion conductivity of general liquid electrolytes at room temperature, and may form an intimate bond between the positive electrode active material and the solid electrolyte without causing a decrease in ion conductivity, and furthermore, an intimate interface between the electrode layer and the solid electrolyte layer. An all-solid-state battery including the same may have improved battery performance such as rate capability, coulombic efficiency, and cycle-life characteristics.

The argyrodite-type sulfide-based solid electrolyte may be prepared, for example, by mixing lithium sulfide and phosphorus sulfide, and optionally lithium halide. Heat treatment may be performed after mixing them. The heat treatment may include, for example, two or more heat treatment steps.

An average particle diameter (D50) of the sulfide-based solid electrolyte particles according to some example embodiments may be less than or equal to about 5.0 m, for example, about 0.1 μm to about 5.0 μm, about 0.1 μm to about 4.0 μm, about 0.1 μm to about 3.0 μm, about 0.5 μm to about 2.0 μm, or about 0.1 μm to about 1.5 μm. Alternatively, the sulfide-based solid electrolyte particles may be small particles having an average particle diameter (D50) of about 0.1 μm to about 1.0 μm or a large particle having an average particle diameter (D50) of about 1.5 μm to about 5.0 μm depending on the location or purpose of use. The sulfide-based solid electrolyte particles having this particle size range can effectively penetrate between solid particles in the battery, and have excellent contact with the electrode active materials and connectivity between solid electrolyte particles. The average particle diameter of the sulfide-based solid electrolyte particles may be measured using a microscope image, and for example, a particle size distribution may be obtained by measuring the size of about 20 particles in a scanning electron microscope image, and D50 may be calculated therefrom.

Meanwhile, the positive electrode for a rechargeable lithium battery may further include an oxide-based inorganic solid electrolyte in addition to the aforementioned sulfide-based solid electrolyte. The oxide-based inorganic solid electrolyte may include, for example, Li₁₊ₓTi₂₋ₓAl(PO₄)₃ (LTAP) (0≤x≤4), Li_{1+x+y}AlₓT₁₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<l), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₂ (M=Te, Nb, or Zr; x is an integer of 1 to 10), or a combination thereof.

A content of the solid electrolyte in the positive electrode for an all-solid-state battery may be about 0.5 wt % to about 35 wt %, for example about 1 wt % to about 35 wt %, about 5 wt % to about 30 wt %, about 8 wt % to about 25 wt %, or about 10 wt % to about 20 wt %. This may be a content based on a total weight of the components in the positive electrode, and specifically, it may be referred to as a content based on a total weight of the positive electrode active material layer.

Binder

The binder may be, for example, polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, acrylated styrene-butadiene rubber, an epoxy resin, nylon, and the like, but is not limited thereto.

A content of the binder in the positive electrode active material layer may be about 0.1 wt % to about 10 wt %, or about 1 wt % to about 5 wt % based on a total weight of the positive electrode active material layer.

Conductive Material

The positive electrode active material layer may further include a conductive material. The conductive material is used to impart conductivity to the electrode, and may include for example a carbon-based material such as natural graphite, artificial graphite, carbon black, acetylene black, Ketjen black, a carbon fiber, a carbon nanotube, and the like; a metal-based material containing copper, nickel, aluminum, silver and the like and in the form of a metal powder or a metal fiber; a conductive polymer such as a polyphenylene derivative; or a combination thereof.

The conductive material may be included in an amount of about 0.1 wt % to about 10 wt %, about 0.1 wt % to about 5 wt %, or about 0.1 wt % to about 3 wt % based on a total weight of each component of the positive electrode for an all-solid-state battery. In the above content range, the conductive material may improve electrical conductivity without degrading battery performance.

Negative Electrode

The negative electrode for an all-solid-state battery may include, for example, a current collector and a negative electrode active material layer on the current collector. The negative electrode active material layer may include a negative electrode active material, and may further include a binder, a conductive material, and/or a solid electrolyte.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be non-shaped, or sheet, flake, spherical, or fiber shaped natural graphite or artificial graphite. The amorphous carbon may be a soft carbon, a hard carbon, a mesophase pitch carbonization product, calcined coke, and the like.

The lithium metal alloy includes an alloy of lithium and one or more metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO₂, Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

The silicon-carbon composite may be, for example, a silicon-carbon composite including a core including crystalline carbon and silicon particles and an amorphous carbon coating layer on the surface of the core. The crystalline carbon may be artificial graphite, natural graphite, or a combination thereof. The amorphous carbon precursor may be a coal-based pitch, mesophase pitch, petroleum-based pitch, coal-based oil, petroleum-based heavy oil, or a polymer resin such as a phenol resin, a furan resin, or a polyimide resin. In this case, the content of silicon may be about 10 wt % to about 50 wt % based on the total weight of the silicon-carbon composite. In addition, the content of the crystalline carbon may be about 10 wt % to about 70 wt % based on the total weight of the silicon-carbon composite, and the content of the amorphous carbon may be about 20 wt % to about 40 wt % based on the total weight of the silicon-carbon composite. In addition, a thickness of the amorphous carbon coating layer may be about 5 nm to about 100 nm.

The average particle diameter (D50) of the silicon particles may be about 10 nm to about 20 μm, for example, about 10 nm to about 500 nm. The silicon particles may be present in an oxidized form, and at this time, an atomic content ratio of Si:O in the silicon particle indicating a degree of oxidation may be about 99:1 to about 33:67. The silicon particles may be SiOₓ particles, and in this case, the range of x in SiOₓ may be greater than about 0 and less than about 2. The average particle diameter (D50) may be measured by a microscope image or a particle size analyzer, and may mean a diameter (D50) of particles having a cumulative volume of 50 volume % in a particle size distribution.

The Si-based negative electrode active material or Sn-based negative electrode active material may be mixed with the carbon-based negative electrode active material. A mixing ratio of the Si-based negative electrode active material or Sn-based negative electrode active material with the carbon-based negative electrode active material may be a weight ratio of about 1:99 to about 90:10.

In the negative electrode active material layer, the negative electrode active material may be included in an amount of about 95 wt % to about 99 wt % based on the total weight of the negative electrode active material layer.

In embodiments, the negative electrode active material layer further includes a binder, and may optionally further include a conductive material. The content of the binder in the negative electrode active material layer may be about 1 wt % to about 5 wt % based on the total weight of the negative electrode active material layer. In addition, if the conductive material is further included, the negative electrode active material layer may include about 90 wt % to about 98 wt % of the negative electrode active material, about 1 wt % to about 5 wt % of the binder, and about 1 wt % to about 5 wt % of the conductive material.

The binder serves to adhere the negative electrode active material particles to each other and also to adhere the negative electrode active material to the current collector. The binder may be a water-insoluble binder, a water-soluble binder, or a combination thereof.

The water-insoluble binder may include, for example polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

If a water-soluble binder is used as the negative electrode binder, a thickener capable of imparting viscosity may be used together, and the thickener may include, for example, a cellulose-based compound. The cellulose-based compound may include carboxymethyl cellulose, hydroxypropylmethyl cellulose, methyl cellulose, an alkali metal salt thereof, or a combination thereof. The alkali metal may be Na, K, or Li. The amount of the thickener used may be about 0.1 parts by weight to about 3 parts by weight based on 100 parts by weight of the negative electrode active material.

The conductive material is included to impart conductivity to the electrode, and may include, for example a carbon-based material such as natural graphite, artificial graphite, carbon black, acetylene black, Ketjen black, a carbon fiber, carbon nanotube, and the like; a metal-based material of a metal powder or a metal fiber including copper, nickel, aluminum silver, and the like; a conductive polymer such as a polyphenylene derivative; or a mixture thereof.

The negative current collector may include one selected from a copper foil, a nickel foil, a stainless steel foil, a titanium foil, a nickel foam, a copper foam, a polymer substrate coated with a conductive metal, and a combination thereof.

According to some example embodiments, the negative electrode for the all-solid-state rechargeable battery may be a precipitation-type negative electrode. The precipitation-type negative electrode may be a negative electrode which includes no negative electrode active material during the assembly of a battery but in which a lithium metal and the like are precipitated during the charge of the battery and serve as a negative electrode active material. In the case of a precipitation-type negative electrode, a negative electrode catalyst layer 403 may be formed on the negative electrode current collector 401 instead of the negative electrode active material layer in FIG. 2. The all-solid-state battery having this precipitation-type negative electrode starts to be initially charged in absence of a negative electrode active material, and a lithium metal with high density and the like are precipitated between the current collector 401 and the negative electrode catalyst layer 403 during the charge and form a lithium metal layer, which may work as a negative electrode active material. Accordingly, the precipitation-type negative electrode, in the all-solid-state battery, which is more than once charged, may include the current collector 401, the lithium metal layer on the current collector, and the negative electrode catalyst layer on the metal layer. The lithium metal layer means a layer of the lithium metal and the like precipitated during the charge of the battery and may be called to be a metal layer, a negative electrode active material layer, or the like.

The negative electrode catalyst layer may include a metal, a carbon material, or a combination thereof which plays a role of a catalyst.

The metal may include, for example, gold, platinum, palladium, silicon silver, aluminum, bismuth, tin, zinc, or a combination thereof and may be composed of one selected therefrom or an alloy of more than one. If the metal is present in particle form, an average particle diameter (D50) thereof may be less than or equal to about 4 μm, for example, about 10 nm to about 4 μm.

The carbon material may be, for example, crystalline carbon, amorphous carbon, or a combination thereof. The crystalline carbon may be for example natural graphite, artificial graphite, mesophase carbon microbeads, or a combination thereof. The amorphous carbon may be for example carbon black, activated carbon, acetylene black, Denka black, Ketjen black, or a combination thereof.

If the negative electrode catalyst layer includes the metal and the carbon material, the metal and the carbon material may be, for example, mixed in a weight ratio of about 1:10 to about 2:1. Herein, the precipitation of the lithium metal may be effectively promoted and improve characteristics of the all-solid-state battery. The negative electrode catalyst layer may include, for example, a carbon material on which a catalyst metal is supported or a mixture of metal particles and carbon material particles.

The negative electrode catalyst layer may include, for example, the metal and amorphous carbon, and in this case, the deposition of lithium metal may be effectively promoted.

The negative electrode catalyst layer may further include a binder, and the binder may be a conductive binder. In addition, the negative electrode catalyst layer may further include general additives such as a filler, a dispersant, and an ion conducting agent.

The negative electrode catalyst layer may have a thickness of, for example, about 100 nm to about 20 μm, about 500 nm to about 10 μm, or about 1 μm to about 5 m.

The precipitation-type negative electrode may further include a thin film, for example, on the surface of the current collector, that is, between the current collector and the negative electrode catalyst layer. The thin film may include an element capable of forming an alloy with lithium. The element capable of forming an alloy with lithium may be, for example, gold, silver, zinc, tin, indium, silicon, aluminum, bismuth, and the like, which may be used alone or an alloy of more than one. The thin film may further planarize a precipitation shape of the lithium metal layer and much improve characteristics of the all-solid-state battery. The thin film may be formed, for example, in a vacuum deposition method, a sputtering method, a plating method, and the like. The thin film may have, for example, a thickness of about 1 nm to about 500 nm.

Solid Electrolyte Layer

The solid electrolyte layer 300 may include a sulfide-based solid electrolyte or an oxide-based solid electrolyte. Details of the sulfide-based solid electrolyte and the oxide-based solid electrolyte are as described above.

In one example, the solid electrolyte included in the positive electrode 200 and the solid electrolyte included in the solid electrolyte layer 300 may include the same compound or different compounds. For example, if both the positive electrode 200 and the solid electrolyte layer 300 include an argyrodite-type sulfide-based solid electrolyte, overall performance of the all-solid-state rechargeable battery may be improved. In addition, for example, if both the positive electrode 200 and the solid electrolyte layer 300 include the aforementioned coated solid electrolyte, the all-solid-state rechargeable battery may implement excellent initial efficiency and cycle-life characteristics while implementing high capacity and high energy density.

Meanwhile, the average particle diameter (D50) of the solid electrolyte included in the positive electrode 200 may be smaller than the average particle diameter (D50) of the solid electrolyte included in the solid electrolyte layer 300. In this case, overall performance can be improved by increasing the mobility of lithium ions while maximizing the energy density of the all-solid-state battery. For example, the average particle diameter (D50) of the solid electrolyte included in the positive electrode 200 may be about 0.1 μm to about 1.0 μm, or about 0.1 μm to about 0.8 μm, and the average particle diameter (D50) of the solid electrolyte included in the solid electrolyte layer 300 may be about 1.5 μm to about 5.0 μm, or about 2.0 μm to about 4.0 μm, or about 2.5 μm to about 3.5 μm. If the particle size ranges are satisfied, the energy density of the all-solid-state rechargeable battery is maximized while the transfer of lithium ions is facilitated, so that resistance is suppressed, and thus the overall performance of the all-solid-state rechargeable battery can be improved. Herein, the average particle diameter (D50) of the solid electrolyte may be measured through a particle size analyzer using a laser diffraction method. Alternatively, about 20 particles may be arbitrarily selected from a micrograph of a scanning electron microscope or the like, the particle size is measured, and a particle size distribution is obtained, and the D50 value may be calculated.

The solid electrolyte layer may further include a binder in addition to the solid electrolyte. Herein, the binder may include a styrene butadiene rubber, polytetrafluoroethylene, polyvinylidene fluoride, polyethylene, an acrylate-based polymer, or a combination thereof, but is not limited thereto. The acrylate-based polymer may be, for example, butyl acrylate, polyacrylate, polymethacrylate, or a combination thereof.

The solid electrolyte layer may be formed by adding a solid electrolyte to a binder solution, coating it on a base film, and drying the resultant. The solvent of the binder solution may be isobutyryl isobutyrate, xylene, toluene, benzene, hexane, or a combination thereof. Since a forming process of the solid electrolyte layer is well known in the art, a detailed description thereof will be omitted.

A thickness of the solid electrolyte layer may be, for example, about 10 μm to about 150 μm.

The solid electrolyte layer may further include an alkali metal salt and/or an ionic liquid and/or a conductive polymer.

The alkali metal salt may be, for example, a lithium salt. The content of the lithium salt in the solid electrolyte layer may be greater than or equal to about 1 M, for example, about 1 M to about 4 M. In this case, the lithium salt may improve ion conductivity by improving lithium ion mobility of the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato) borate (LiBOB), lithium oxalyldifluoroborate (LIODFB), lithium difluoro(oxalato) borate (LiDFOB), lithium bis(trifluoromethanesulfonyl)imide (LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄, or a mixture thereof.

In addition, the lithium salt may be an imide-based salt, for example, the imide-based lithium salt may be lithium bis(trifluoromethanesulfonyl) imide (LiTFSI, LiN(SO₂CF₃)₂), and lithium bis(fluorosulfonyl)imide (LiFSI, LiN(SO₂F)₂). The lithium salt may maintain or improve ion conductivity by appropriately maintaining chemical reactivity with the ionic liquid.

The ionic liquid has a melting point below room temperature, so it is in a liquid state at room temperature and refers to a salt or room temperature molten salt composed of ions alone.

The ionic liquid may be a compound including at least one cation selected from a) ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, triazolium-based, and a mixture thereof, and at least one anion selected from BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)₂N—, (C₂F₅SO₂)(CF₃SO₂)N—, and (CF₃SO₂)₂N—.

The ionic liquid may be, for example, one or more selected from N-methyl-N-propylpyrrolidinium bis(trifluoromethanesulfonyl)imide N-butyl-N-methylpyrrolidium bis(3-trifluoromethylsulfonyl) imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be about 0.1:99.9 to about 90:10, for example, about 10:90 to about 90:10, about 20:80 to about 90:10, about 30:70 to about 90:10, about 40:60 to about 90:10, or about 50:50 to about 90:10. The solid electrolyte layer satisfying the above ranges may maintain or improve ion conductivity by improving the electrochemical contact area with the electrode. Accordingly, the energy density, discharge capacity, rate capability, etc. of the all-solid-state battery may be improved.

The shape of the all-solid-state battery is not particularly limited, and may be, for example, a coin type, a button type, a sheet type, a stack type, a cylindrical shape, a flat type, and the like. In addition, the all-solid-state battery may be applied to a large-sized battery used in an electric vehicle or the like. For example, the all-solid-state battery may also be used in a hybrid vehicle such as a plug-in hybrid electric vehicle (PHEV). In addition, it may be used in a field requiring a large amount of power storage, and may be used, for example, in an electric bicycle or a power tool.

Hereinafter, examples of the present invention and comparative examples are described. It is to be understood, however, that the examples are for the purpose of illustration and are not to be construed as limiting the present invention.

### Example 1

1. Preparation of Battery Assembly

(1) Preparation of Positive Electrode

84.9 wt % of LiNi_{0.945}Co_{0.04}Al_{0.015}O₂ of a positive electrode active material, 13.51 wt % of Li₆PS₅Cl of an argyrodite-type sulfide-based solid electrolyte, 1 wt % of a PVDF binder, and 0.35 wt % of a carbon nanotube conductive material are added to an isobutyryl isobutyrate (IBIB) solvent to prepare a positive electrode composition. The prepared positive electrode composition is coated on a positive electrode current collector and then dried and compressed to manufacture a positive electrode.

(2) Preparation of Solid Electrolyte Layer

An argyrodite-type solid electrolyte of Li₆PS₅Cl is added to an IBIB solvent to which an acryl-based binder is included, preparing a composition for a solid electrolyte layer. The composition is cast on a releasing film and then dried at room temperature, forming a solid electrolyte layer.

(3) Preparation of Negative Electrode

After preparing a catalyst by mixing carbon black with a primary particle diameter of about 30 nm and silver (Ag) with an average particle diameter (D50) of about 60 nm in a weight ratio of 3:1, 0.25 g of the catalyst is added to 2 g of an NMP solution including 7 wt % of a polyvinylidene fluoride binder and then, mixed, preparing a negative electrode catalyst layer composition. This composition is coated on a negative electrode current collector and dried, preparing a precipitation-type negative electrode having a negative electrode catalyst layer on the current collector.

(4) Preparation of Unit Cell

The prepared positive and negative electrodes and the solid electrolyte layer are cut, and after stacking the solid electrolyte layer on the positive electrode, the negative electrode is stacked thereon to manufacture a unit cell.

(5) Preparation of Cell Stack

After preparing 5 of the unit cells, an elastic sheet is interposed between the unit cells and on both surfaces to manufacture a cell stack. The elastic sheet is formed of polyurethane with T_{g} of −50° C. and has a thickness of about 300 μm (Main Elecom Co., Ltd.).

2. Preparation of all-Solid-State Rechargeable Battery Module

The prepared stack is pressurized at 6 MPa. The pressurized stack is cooled to about 0° C. to obtain the stack maintained in the pressurized state. This cooled stack is inserted into a battery case in the form of a prismatic can. Subsequently, the temperature is increased to room temperature of about 25° C. to manufacture an all-solid-state rechargeable battery module, in which the elastic sheet may recover an elastic force to increase a volume of the stack and generate an internal pressure.

It takes about 60 seconds, until the stack is put into a battery case after the cooling, for which the stack does not expand but maintains the pressurized state.

### Example 2

An all-solid-state rechargeable battery module is manufactured in the same manner as in Example 1 except that the elastic sheet is replaced with an elastic sheet formed of 2-ethylhexylacrylate and having T_{g} of about −50° C.

### Example 3

An all-solid-state rechargeable battery module is manufactured in the same manner as in Example 1 except that the elastic sheet is replaced with an elastic sheet formed silicon and having T_{g} of about −125° C.

### Evaluation Example 1

If an elastic sheet has strong adhesiveness, there are difficulties in handling it in the process. According to some example embodiments, there may be an effect of reducing the adhesiveness through the cooling process by using a polymer T_{g}. The elastic sheet used in Example 1 is measured with respect to adhesion strength at 25° C., 20° C., 15° C., 10° C., 5° C., 2° C., and −4° C., and the results are shown in Table 1. Herein, the adhesion strength is measured by using a texture analyzer (TA).

TABLE 1

| Cooling temperature (° C.) | Adhesion strength (MPa) |
|---|---|
| −4 | 0.068 |
| 2 | 0.152 |
| 5 | 0.234 |
| 10 | 0.316 |
| 15 | 0.301 |
| 20 | 0.320 |
| 25 | 0.323 |

Referring to Table 1, the adhesion strength decreases from 0.323 MPa at 25° C. to 0.068 MPa at −4° C.

In the all-solid-state rechargeable battery, unlike a conventional liquid electrolyte battery, electrode materials should maintain point contacts to transfer ions through a solid material, which may be achieved by maintaining a cell entirely in a pressurized state.

The volume of the all-solid-state rechargeable battery expands, as lithium metal is electrodeposited on a negative electrode during the charge, but shrinks in volume, as the lithium metal is ionized during the discharge. Since this volume change in the pressurized state causes a pressure change, in order to endure this, a structure of interposing an elastic sheet or a buffer layer at an outermost surface of a cell stack or between unit cells has been proposed. The elastic sheet may contract, if the battery volume increases, to minimize the internal pressure increase but rapidly expand, if the battery volume decreases, to maintain the point contacts of the solid materials. In addition, the lithium metal may be non-uniformly formed on the negative electrode during the discharge, or the battery may have no uniform thickness, wherein the elastic sheet may relieve stress inside the battery and thus minimize the curvature of the electrode surface. In addition, the all-solid-state rechargeable battery is vulnerable to impacts, but the elastic sheet serves to absorb the external impacts to improve safety of the battery.

However, the cell stack, in which the elastic sheet is interposed between the cells, in the pressurized state is impossible to insert into a hard battery case due to an elastic force of the elastic sheet itself. Accordingly, a flexible battery case such as a pouch type case and the like may be applied thereto, but since a metal endplate may be additionally required to apply a pressure to the cell stack, there are problems of requiring an additional design to the manufacturing process and increasing a cost.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

Example embodiments have been disclosed herein, and although specific terms are employed, they are used and are to be interpreted in a generic and descriptive sense only and not for the purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

### REFERENCE NUMERAL

100: all-solid-state rechargeable battery
200: positive electrode
201: positive electrode current collector
203: positive electrode active material layer
300: solid electrolyte layer
400: negative electrode
401: negative current collector
403: negative electrode active material layer or negative electrode catalyst layer
500: elastic sheet
600: battery case

What is claimed is:

1. A preparing method of an all-solid-state rechargeable battery module, comprising:
preparing a stack having two or more unit cells, each unit cell having a positive electrode, a negative electrode, and a solid electrolyte layer between the positive electrode and the negative electrode,
providing an elastic sheet containing a polymer between the unit cells,
pressurizing the stack,
cooling the pressurized stack to obtain a stack in a pressurized state,
inserting the cooled stack in a pressurized state into a battery case, and
heating the battery case and the inserted stack.

2. The preparing method as claimed in claim 1, wherein the elastic sheet is provided with a polymer having a glass transition temperature (T_{g}) of about −150° C. to about 0° C.

3. The preparing method as claimed in claim 1, wherein:
cooling the pressurized stack is conducted to lower a temperature of the pressurized stack to less than about 5° C., and
heating the battery case and the inserted stack is conducted to raise a temperature of the battery case and inserted stack to greater than or equal to about 5° C.

4. The preparing method as claimed in claim 1, wherein cooling the pressurized stack is conducted to lower a temperature of the pressurized stack to a range of ±50° C. of a glass transition temperature of the polymer in the elastic sheet and less than about 5° C.

5. The preparing method as claimed in claim 1, wherein heating the battery case and the inserted stack is conducted to raise a temperature of the battery case and inserted stack to room temperature (20±5° C.).

6. The preparing method as claimed in claim 1, wherein pressurizing the stack is conducted at a pressure of about 1 MPa to about 10 MPa.

7. The preparing method as claimed in claim 1, wherein:
in pressurizing the stack, the elastic sheet shrinks in a thickness direction, and
a compressive strain of the elastic sheet by the pressurizing is about 30% to about 70%.

8. The preparing method as claimed in claim 1, wherein:
a thickness of the elastic sheet before the pressurizing is about 50 μm to about 500 μm, and
a thickness of the elastic sheet after the pressurizing is about 15 μm to about 350 μm.

9. The preparing method as claimed in claim 1, wherein during heating of the battery case and the inserted stack, the elastic sheet expands about 40 μm to about 400 μm in a thickness direction.

10. The preparing method as claimed in claim 1, wherein the polymer of the elastic sheet includes polyurethane, polyacrylate, silicon, fluorine-based polymer, a copolymer thereof, or a combination thereof.

11. The preparing method as claimed in claim 1, wherein the elastic sheet is provided at an outermost side of the stack inside the battery case, before pressurizing the stack.

12. The preparing method as claimed in claim 1, wherein the battery case is a can type.

13. The preparing method as claimed in claim 1, wherein the battery case is a prismatic can.

14. An all-solid-state rechargeable battery, comprising:
a stack having two or more unit cells, each unit cell including
a positive electrode,
a negative electrode, and
a solid electrolyte layer between the positive electrode and the negative electrode,
an elastic sheet between the unit cells, and
a battery case housing the stack,
wherein the elastic sheet includes a polymer, and
the polymer has a glass transition temperature (T_{g}) of about −150° C. to about 0° C.

15. The all-solid-state rechargeable battery as claimed in claim 14, wherein the polymer of the elastic sheet includes polyurethane, polyacrylate, silicon, fluorine-based polymer, a copolymer thereof, or a combination thereof.

16. The all-solid-state rechargeable battery as claimed in claim 14, wherein the elastic sheet in the battery case has a thickness of about 40 μm to about 400 μm.

17. The all-solid-state rechargeable battery as claimed in claim 14, wherein the elastic sheet has a compressive strain of about 30% to about 70% under a pressure of 6 MPa at 25° C.

18. The all-solid-state rechargeable battery as claimed in claim 14, wherein the battery case is a can type.

19. The all-solid-state rechargeable battery as claimed in claim 14, wherein the battery case is a prismatic can.

20. The all-solid-state rechargeable battery as claimed in claim 14, wherein the elastic sheet is at an outermost side of the stack inside the battery case.
